(19) United States
(12) Patent Application Publication
(10) Pub. No.: US 2008/0175223 A1
(43) Pub. Date: Jul. 24, 2008

(54) Method and apparatus for providing multiple calling name identifiers for a phone number

(76) Inventors: Marian Croak, Fair Haven, NJ (US); Hossein Eslambolchi, Los Altos Hills, CA (US)

Correspondence Address: AT&T CORP., ROOM 2A207, ONE AT&T WAY, BEDMINSTER, NJ, 07921, US

(21) Appl. No.: 11/025,234

(22) Filed: Dec. 29, 2004

(51) Int. Cl. H04L 12/66

(52) U.S. Cl. 370/352

(57) ABSTRACT

The present invention enables users of a packet-switched network service, e.g., a VoIP network service who live in the same household and share a common phone number to have individualized calling name identifiers transmitted in their call setup messages. Each user in the household would have a different individual user identifier which they could dial to signal to the network immediately before dialing the phone number when they want to place a call that would transmit their personalized individual calling name identifier in the call setup message.

The present invention relates generally to communication networks and, more particularly, to a method and apparatus for enabling multiple calling name identifiers for individual phone numbers in packet switched networks, e.g., Voice over Internet Protocol (VoIP) networks.

### BACKGROUND OF THE INVENTION

Members of a household often share a common phone number. When individuals in a household place a call using a phone tied to the common phone number, the calling party identification that gets transmitted in the call setup message is the name associated with the registered billing party. Other users of the same phone number will not be able to use their individual calling name information when making a phone call.

Therefore, a need exists for a method and apparatus for enabling multiple calling name identifiers for individual phone numbers in packet switched networks, e.g., Voice over Internet Protocol (VoIP) networks.

### SUMMARY OF THE INVENTION

In one embodiment, the present invention enables users of a packet switched network service, e.g., a VoIP network service, who live in the same household and share a common phone number to have individualized calling name identifiers transmitted in their call setup messages. Each user in the household would have a different user identifier which they could dial to signal to the communication network immediately before dialing the phone number when they want to place a call that would transmit their personalized calling name identifier in the call setup message. For instance, user 1 in the household can dial *901 to select the corresponding calling name identification to be used for one call and user 2 in the household can dial *902 to select the corresponding calling name identification to be used for another call.

### BRIEF DESCRIPTION OF THE DRAWINGS

The teaching of the present invention can be readily understood by considering the following detailed description in conjunction with the accompanying drawings, in which:

FIG. 1 illustrates an exemplary Voice over Internet Protocol (VoIP) network related to the present invention;

FIG. 2 illustrates an example of enabling multiple calling name identifiers for an individual phone number in a VoIP network of the present invention;

FIG. 3 illustrates a flowchart of a method for registering multiple calling name identifiers for an individual phone number in a VoIP network of the present invention;

FIG. 4 illustrates a flowchart of a method for enabling multiple calling name identifiers for an individual phone number in a VoIP network of the present invention; and

FIG. 5 illustrates a high level block diagram of a general purpose computer suitable for use in performing the functions described herein.

To facilitate understanding, identical reference numerals have been used, where possible, to designate identical elements that are common to the figures.

### DETAILED DESCRIPTION

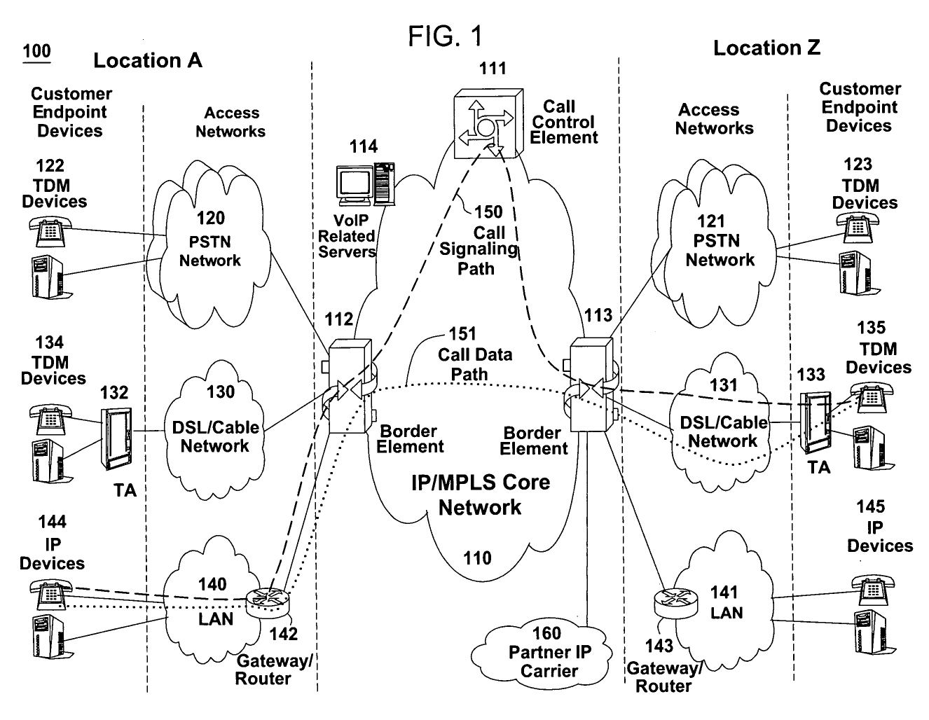

To better understand the present invention, FIG. 1 illustrates an example network, e.g., a packet-switched network such as a VoIP network related to the present invention. The VoIP network may comprise various types of customer endpoint devices connected via various types of access networks to a carrier (a service provider) VoIP core infrastructure over an Internet Protocol/Multi-Protocol Label Switching (IP/MPLS) based core backbone network. Broadly defined, a VoIP network is a network that is capable of carrying voice signals as packetized data over an IP network. An IP network is broadly defined as a network that uses Internet Protocol to exchange data packets.

The customer endpoint devices can be either Time Division Multiplexing (TDM) based or IP based. TDM based customer endpoint devices 122, 123, 134, and 135 typically comprise of TDM phones or Private Branch Exchange (PBX). IP based customer endpoint devices 144 and 145 typically comprise IP phones or PBX. The Terminal Adaptors (TA) 132 and 133 are used to provide necessary interworking functions between TDM customer endpoint devices, such as analog phones, and packet based access network technologies, such as Digital Subscriber Loop (DSL) or Cable broadband access networks. TDM based customer endpoint devices access VoIP services by using either a Public Switched Telephone Network (PSTN) 120, 121 or a broadband access network via a TA 132 or 133. IP based customer endpoint devices access VoIP services by using a Local Area Network (LAN) 140 and 141 with a VoIP gateway or router 142 and 143, respectively.

The access networks can be either TDM or packet based. A TDM PSTN 120 or 121 is used to support TDM customer endpoint devices connected via traditional phone lines. A packet based access network, such as Frame Relay, ATM, Ethernet or IP, is used to support IP based customer endpoint devices via a customer LAN, e.g., 140 with a VoIP gateway and router 142. A packet based access network 130 or 131, such as DSL or Cable, when used together with a TA 132 or 133, is used to support TDM based customer endpoint devices.

The core VoIP infrastructure comprises of several key VoIP components, such the Border Element (BE) 112 and 113, the Call Control Element (CCE) 111, and VoIP related servers 114. The BE resides at the edge of the VoIP core infrastructure and interfaces with customers endpoints over various types of access networks. A BE is typically implemented as a Media Gateway and performs signaling, media control, security, and call admission control and related functions. The CCE resides within the VoIP infrastructure and is connected to the BEs using the Session Initiation Protocol (SIP) over the underlying IP/MPLS based core backbone network 110. The CCE is typically implemented as a Media Gateway Controller and performs network wide call control related functions as well as interacts with the appropriate VoIP service related servers when necessary. The CCE functions as a SIP back-to-back user agent and is a signaling endpoint for all call legs between all BEs and the CCE. The CCE may need to interact with various VoIP related servers in order to complete a call that require certain service specific features, e.g. translation of an E.164 voice network address into an IP address.

For calls that originate or terminate in a different carrier, they can be handled through the PSTN 120 and 121 or the Partner IP Carrier 160 interconnections. For originating or terminating TDM calls, they can be handled via existing PSTN interconnections to the other carrier. For originating or terminating VoIP calls, they can be handled via the Partner IP carrier interface 160 to the other carrier.

In order to illustrate how the different components operate to support a VoIP call, the following call scenario is used to illustrate how a VoIP call is setup between two customer endpoints. A customer using IP device 144 at location A places a call to another customer at location Z using TDM device 135. During the call setup, a setup signaling message is sent from IP device 144, through the LAN 140, the VoIP Gateway/Router 142, and the associated packet based access network, to BE 112. BE 112 will then send a setup signaling message, such as a SIP-INVITE message if SIP is used, to CCE 111. CCE 111 looks at the called party information and queries the necessary VoIP service related server 114 to obtain the information to complete this call. If BE 113 needs to be involved in completing the call; CCE 111 sends another call setup message, such as a SIP-INVITE message if SIP is used, to BE 113. Upon receiving the call setup message, BE 113 forwards the call setup message, via broadband network 131, to TA 133. TA 133 then identifies the appropriate TDM device 135 and rings that device. Once the call is accepted at location Z by the called party, a call acknowledgement signaling message, such as a SIP-ACK message if SIP is used, is sent in the reverse direction back to the CCE 111. After the CCE 111 receives the call acknowledgement message, it will then send a call acknowledgement signaling message, such as a SIP-ACK message if SIP is used, toward the calling party. In addition, the CCE 111 also provides the necessary information of the call to both BE 112 and BE 113 so that the call data exchange can proceed directly between BE 112 and BE 113. The call signaling path 150 and the call data path 151 are illustratively shown in FIG. 1. Note that the call signaling path and the call data path are different because once a call has been setup up between two endpoints, the CCE 111 does not need to be in the data path for actual direct data exchange.

Note that a customer in location A using any endpoint device type with its associated access network type can communicate with another customer in location Z using any endpoint device type with its associated network type as well. For instance, a customer at location A using IP customer endpoint device 144 with packet based access network 140 can call another customer at location Z using TDM endpoint device 123 with PSTN access network 121. The BEs 112 and 113 are responsible for the necessary signaling protocol translation, e.g., SS7 to and from SIP, and media format conversion, such as TDM voice format to and from IP based packet voice format.

Members of a household often share a common phone number. When individuals in a household place a call using a phone tied to the common phone number, the calling party identification that gets transmitted in the call setup message is the name associated with the registered billing party. Other users of the same phone number will not be able to use their individual calling name information when making a phone call.

To address this need, the present invention enables users of a packet switched network service, e.g., a VoIP network service, who live in the same household and share a common phone number to have individualized calling name identifiers transmitted in their call setup messages. Each user in the household would have a different user identifier which they could dial to signal to the network immediately before dialing the phone number when they want to place a call that would transmit their personalized calling name identifier in the call setup message. For instance, user 1 in the household can dial *901 to select the corresponding calling name identification to be used for one call and user 2 in the household can dial *902 to select the corresponding calling name identification to be used for another call.

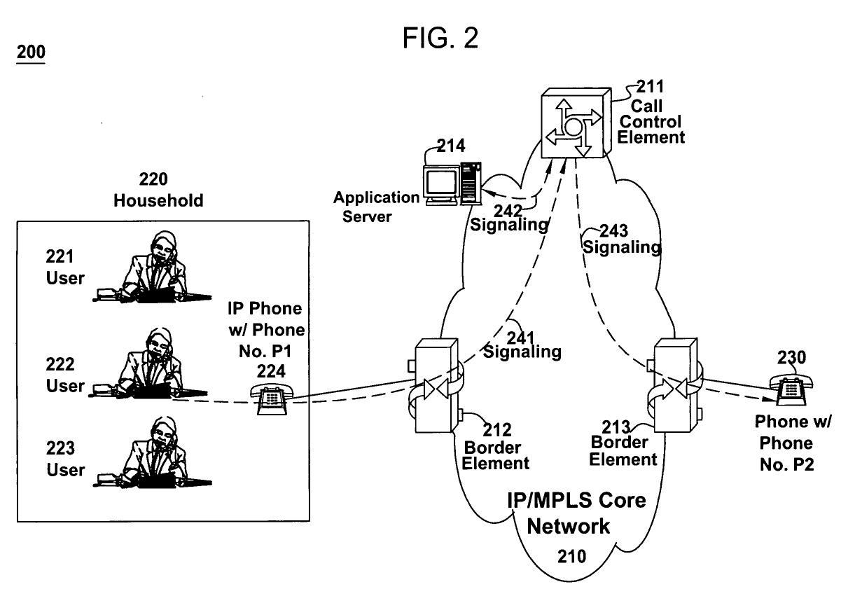

FIG. 2 illustrates an example of providing multiple calling name identifiers for an individual phone number in a packet switched network, e.g., a VoIP network. In FIG. 2, household 220 has 3 users, 221, 222, and 223, sharing a single IP phone 224 with a single phone number P1. User 221 is the registered billing user of the phone account. The default calling name identifier is the billing user's name and the calling number identifier is phone number P1. User 221 also has signed up for the individual calling name identifier service feature. User 222 and user 223 have also registered their own calling name identifiers with the network provider. User identifiers used to identify individual calling users have also been assigned to users 221, 222, and 223.

In one example, user 222 makes a call by dialing the pre-assigned user identifier of user 222 immediately before dialing phone number P2 associated with phone 230. CCE 211 receives a call setup message 241 via BE 212 containing the user identifier of user 222 from IP phone 224. CCE 211 accesses Application Server (AS) 214 via flow 242 to find out that the calling number account has registered for the individual calling name identifier service feature. CCE 211 finds out that the call setup message contains an individual user identifier belonging to user 222. CCE 211 retrieves the corresponding calling name identifier of the user identifier of user 222 from AS 214. Then CCE 211 continues the call setup message via flow 243 towards the called party via BE 213 using the retrieved calling name identifier of the calling user 222.

In the case that no individual user identifier is contained in the call setup message, the default calling name identifier of user 221 will be used.

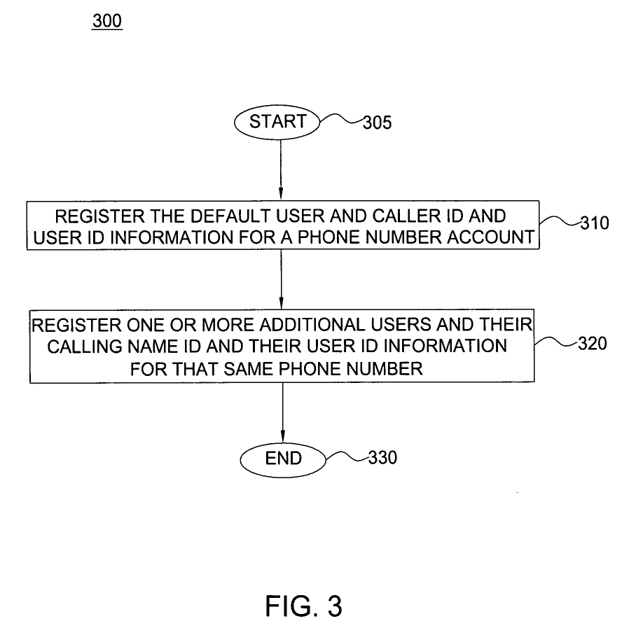

FIG. 3 illustrates a flowchart of a method for registering multiple calling name identifiers for an individual phone number in a packet switched network, e.g., a VoIP network. Method 300 starts in step 305 and proceeds to step 310.

In step 310, the method registers the default billing party user's calling number identifier, at least one individual calling name identifier, and at least one individual user identifier. The registration can be implemented via a website, an interactive Voice Response (IVR) system or a customer care representative.

In step 320, the method registers one or more additional users and their own individual calling name identifiers (e.g., John Doe, Jane Doe, and so on) and user identifiers (e.g., predefined Dual Tone Multiple Frequency (DTMF) signals) associated with the billing party user's phone number account. The method ends in step 330.

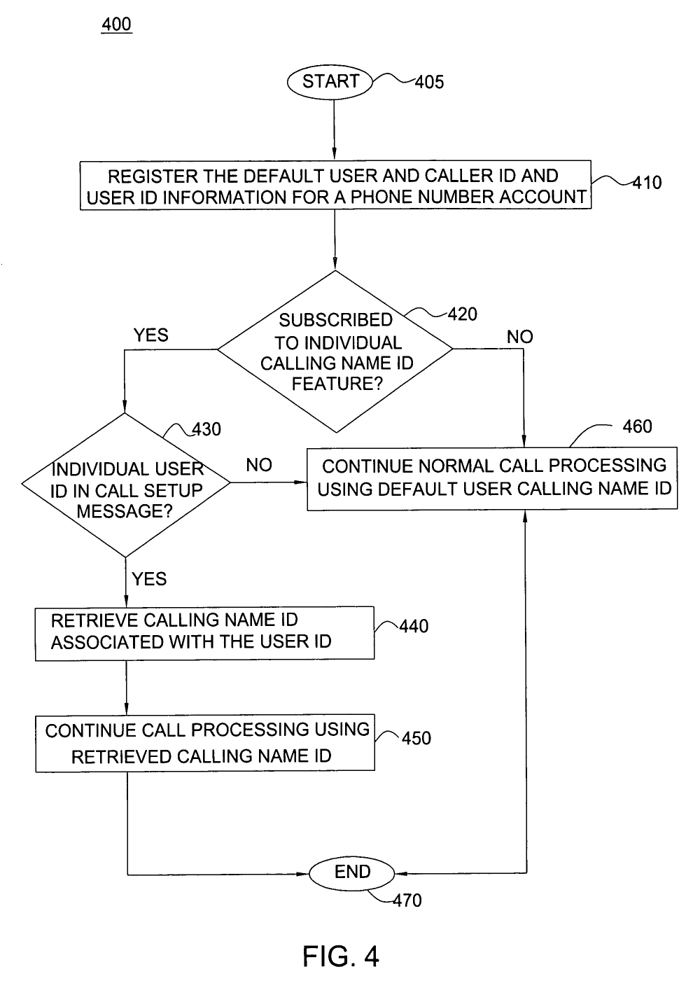

FIG. 4 illustrates a flowchart of a method for enabling multiple calling name identifiers for an individual phone number, e.g., by a CCE in a packet-switched network, e.g., a VoIP network. Method 400 starts in step 405 and proceeds to step 410.

In step 410, the method receives a call setup message from a subscriber. In step 420, the method checks if the calling number has subscribed to the individual calling name identifier service feature. If the calling number is associated as being subscribed to the individual calling name identifier service feature, the method proceeds to step 430; otherwise, the method proceeds to 460. In step 430, the method checks if the call setup message contains an individual user identifier. If the call setup message contains an individual user identifier, the method proceeds to step 440; otherwise, the method proceeds to step 460. In step 440, the method retrieves the corresponding calling name identifier associated with the individual user identifier from the Application Server. In step 450, the method continues the call setup message to the called party number by using the retrieved calling name identifier in the calling name identifier field in the call setup message. In step 460, the method continues the call setup message to the called party number by using the default calling name identifier in the calling name identifier field in the call setup message. The method ends in step 470.

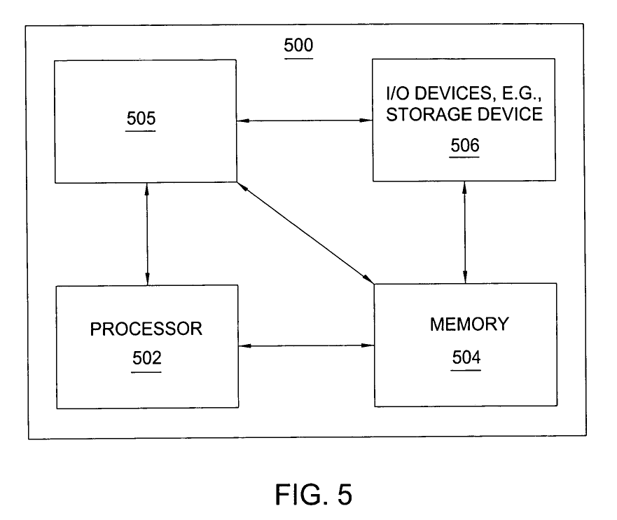

FIG. 5 depicts a high level block diagram of a general purpose computer suitable for use in performing the functions described herein. As depicted in FIG. 5, the system 500 comprises a processor element 502 (e.g., a CPU), a memory 504, e.g., random access memory (RAM) and/or read only memory (ROM), an individual calling name identifier module 505, and various input/output devices 506 (e.g., storage devices, including but not limited to, a tape drive, a floppy drive, a hard disk drive or a compact disk drive, a receiver, a transmitter, a speaker, a display, a speech synthesizer, an output port, and a user input device (such as a keyboard, a keypad, a mouse, and the like)).

It should be noted that the present invention can be implemented in software and/or in a combination of software and hardware, e.g., using application specific integrated circuits (ASIC), a general purpose computer or any other hardware equivalents. In one embodiment, the present individual calling name identifier module or process 505 can be loaded into memory 504 and executed by processor 502 to implement the functions as discussed above. As such, the present individual calling name identifier process 505 (including associated data structures) of the present invention can be stored on a computer readable medium or carrier, e.g., RAM memory, magnetic or optical drive or diskette and the like.

While various embodiments have been described above, it should be understood that they have been presented by way of example only, and not limitation. Thus, the breadth and scope of a preferred embodiment should not be limited by any of the above-described exemplary embodiments, but should be defined only in accordance with the following claims and their equivalents.

What is claimed is:

1. A method for providing a plurality of calling name identifiers for a phone number in a communication network, comprising:
receiving a call setup message for a call from a calling party;
determining whether said call setup message contains an individual user identifier, where said user identifier is associated with an individual calling name identifier that is different than a default calling name identifier associated with said calling party;
retrieving said individual calling name identifier associated with said individual user identifier if said call setup message contains said individual user identifier; and
processing said call using said individual calling name identifier.

2. The method of claim 1, wherein said communication network is a Voice over Internet Protocol (VoIP) network.

3. The method of claim 1, wherein said processing comprises:
inserting said individual calling name identifier in said call setup message; and
forwarding said call setup message towards a called party of said call.

4. The method of claim 1, wherein said determining is performed by a call control element (CCE).

5. The method of claim 4, wherein said individual calling name identifier is retrieved by said CCE from an application server (AS).

6. The method of claim 1, wherein said individual user identifier is a pre-assigned dual tone multiple frequency (DTMF) signal.

7. The method of claim 1, wherein said individual calling name identifier is previously registered.

8. A computer-readable medium having stored thereon a plurality of instructions, the plurality of instructions including instructions which, when executed by a processor, cause the processor to perform the steps of a method for providing a plurality of calling name identifiers for a phone number in a communication network, comprising:
receiving a call setup message for a call from a calling party;
determining whether said call setup message contains an individual user identifier, where said user identifier is associated with an individual calling name identifier that is different than a default calling name identifier associated with said calling party;
retrieving said individual calling name identifier associated with said individual user identifier if said call setup message contains said individual user identifier; and
processing said call using said individual calling name identifier.

9. The computer-readable medium of claim 8, wherein said communication network is a Voice over Internet Protocol (VoIP) network.

10. The computer-readable medium of claim 8, wherein said processing comprises:
inserting said individual calling name identifier in said call setup message; and
forwarding said call setup message towards a called party of said call.

11. The computer-readable medium of claim 8, wherein said determining is performed by a call control element (CCE).

12. The computer-readable medium of claim 11, wherein said individual calling name identifier is retrieved by said CCE from an application server (AS).

13. The computer-readable medium of claim 8, wherein said individual user identifier is a pre-assigned dual tone multiple frequency (DTMF) signal.

14. The computer-readable medium of claim 8, wherein said individual calling name identifier is previously registered.

15. A system for providing a plurality of calling name identifiers for a phone number in a communication network, comprising:
means for receiving a call setup message for a call from a calling party;
means for determining whether said call setup message contains an individual user identifier, where said user identifier is associated with an individual calling name identifier that is different than a default calling name identifier associated with said calling party;
means for retrieving said individual calling name identifier associated with said individual user identifier if said call setup message contains said individual user identifier; and
means for processing said call using said individual calling name identifier.

16. The system of claim 15, wherein said communication network is a Voice over Internet Protocol (VoIP) network.

17. The system of claim 15, wherein said processing means comprises:
means for inserting said individual calling name identifier in said call setup message; and
means for forwarding said call setup message towards a called party of said call.

18. The system of claim 15, wherein said determining is performed by a call control element (CCE).

19. The system of claim 18, wherein said individual calling name identifier is retrieved by said CCE from an application server (AS).

20. The system of claim 15, wherein said individual user identifier is a pre-assigned dual tone multiple frequency (DTMF) signal.
